(19) United States
(12) Patent Application Publication
(10) Pub. No.: US 2018/0248342 A1
(43) Pub. Date: Aug. 30, 2018

(54) PANELS AND ENCLOSURES WITH COMPONENT POSITIONING TEMPLATES

(71) Applicant: Hubbell Incorporated, Shelton, CT (US)

(72) Inventors: Donald Wayne Nicholas, III, Staunton, IL (US); Richard Jon Wagner, Crown Point, IN (US); Terry Michael Shylanski, St. Louis, MO (US); Scott Louis Smith, Cedar Hill, MO (US); David Roy Harms, Marissa, IL (US)

(21) Appl. No.: 15/906,433

(22) Filed: Feb. 27, 2018

Related U.S. Application Data
(60) Provisional application No. 62/464,863, filed on Feb. 28, 2017.

(51) Int. Cl. H02B 1/48; H02B 1/24

(52) U.S. Cl. CPC H02B 1/48; H02B 1/24

(57) ABSTRACT

A panel positioning template includes a substrate and a template provided on the substrate and providing a visual indication for positioning of electrical and/or electronic components. The panel positioning template may be mounted to a panel or to one or more walls of an enclosure.

### CROSS REFERENCE TO RELATED APPLICATIONS

The present application is based on and claims the benefit from co-pending U.S. Patent Application Ser. No. 62/464,863, filed on Feb. 28, 2017 entitled “Panels and Enclosures with Component Positioning Templates” the entire contents of which are incorporated herein by reference.

### BACKGROUND

### Field

The present disclosure relates generally to panels and enclosures and, more particularly, to panels and enclosures with component positioning templates.

### Description of the Related Art

Electronic components including, for example, switches, routers, relays, storage devices, transformers, circuit breaker buses, fuse buses, bus bars, etc. are often mounted together on a panel or in an enclosure. A panel is typically a plate like structure on which components can be mounted. An enclosure generally includes a frame or box having top and bottom walls, side walls and a rear wall. The enclosure may include an enclosure panel mounted within the frame and a removable cover or door. The enclosure panel is mounted within the frame and typically offset from the rear wall. The door may include a latch and/or a locking mechanism. Panels are generally made from metal, aluminum, steel or other such material. Enclosures are generally made from metal, aluminum, steel, rigid plastic or other such materials. Panels and enclosures may be provided in various sizes to suit particular applications. For example, an enclosure may be selected having a particular depth, width and height to suit the particular electronic components being mounted therein.

The electronic components are generally mounted to the panel or the enclosure panel by strategically drilling and tapping holes into the panel or enclosure panel. To provide a professional, neat and functional panel, the electronic components should be mounted parallel, perpendicular and/or straight. Accordingly, drilling and tapping the back panel can be tedious and time consuming. In addition, once the electronic components are mounted to the back panel, wiring the electronic components can be confusing and difficult using typical wiring schematics.

### SUMMARY

A panel positioning template includes a substrate and a template provided on the substrate and providing a visual indication for positioning of electronic components.

A panel enclosure includes four side panels forming an enclosed area, a back panel enclosing a back of the enclosed area and a positioning template provided on the back panel, the positioning template providing a visual indication for positioning electronic components.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a front plan view of a panel including a positioning template according to an illustrative embodiment of the present disclosure;

FIG. 2A is a partial cross-sectional view of the panel including the positioning template depicted in FIG. 1 taken along lines 2A-2A;

FIG. 2B is a partial end elevation view of another illustrative embodiment of the panel including the positioning template on a substrate;

FIG. 3 is a front plan view of a panel including a positioning template according to an illustrative embodiment of the present disclosure;

FIG. 4A is a partial cross-sectional view of the panel including the positioning template depicted in FIG. 3 taken along lines 4A-4A;

FIG. 4B is a partial end elevation view of another illustrative embodiment of the panel including the positioning template on a substrate;

FIG. 5 is a front view of a panel including a positioning template according to an illustrative embodiment of the present disclosure;

FIG. 6A is a partial cross-sectional view of the panel including the positioning template depicted in FIG. 5 taken along lines 6A-6A;

FIG. 6B is a partial end elevation view of another illustrative embodiment of the panel including the positioning template on a substrate;

FIG. 7 is a front view of a sheet of material including electronic component schematic representations according to an illustrative embodiment of the present disclosure;

FIG. 8 is a front perspective view of an electronic component enclosure according to an illustrative embodiment of the present disclosure;

FIG. 9 is an exploded view of the electronic component enclosure of FIG. 8; and

FIG. 10 is a front perspective view of another exemplary embodiment of an electronic component enclosure according to the present disclosure.

### DETAILED DESCRIPTION

Illustrative embodiments of the present disclosure may be provided as improvements to panels, such as electronic component panels, to which electrical and/or electronic components are mounted. Illustrative embodiments of the present disclosure may be provided as improvements to enclosures, such as electronic component enclosures, in which electrical and/or electronic components are mounted. In illustrative embodiments, the electrical and/or electronic components are mounted to on at least one wall, e.g., the rear wall, in the enclosure. In illustrative embodiments, the enclosures may have an enclosure panel in which case the electrical and/or electronic components are mounted to the enclosure panel. In illustrative embodiments, the enclosures may include a swing panel that is pivotable secured to at least one of the side panels forming the enclosure. The swing panel has a front surface and a rear surface. For the purpose of this disclosure, the panel and enclosure panel may collectively be referred to herein as the “panel.”

According to an illustrative embodiment of the present disclosure the panel includes a positioning template allowing, for example, electrical and/or electronic components to be readily mounted to the panel, to one or more walls within the enclosure and/or to the swing panel in predefined manner in accordance with design specifications, and possibly so that the electrical and/or electronic components are oriented in a parallel and/or perpendicular manner.

According to an illustrative embodiment of the present disclosure, the positioning template may be in the form of a grid-like pattern. According to another illustrative embodiment of the present disclosure, the positioning template may be in the form of a schematic-like representation of the electronic components to be mounted to the panel. According to another illustrative embodiment of the present disclosure, the positioning template may be in the form of a grid-like pattern and a schematic-like representation.

According to illustrative embodiments of the present disclosure, the positioning template may be permanent or removable. According to an illustrative embodiment of the present disclosure, the positioning template may be etched into the panel. According to another illustrative embodiment of the present disclosure, the positioning template may be marked onto the panel using at least one of permanent or removable markings.

According to illustrative embodiments of the present disclosure, the positioning template may be provided on a substrate capable of being attached to the panel or to one or more walls of the enclosure. According to an illustrative embodiment of the present disclosure, the substrate may include at least one of cardboard, plastic, laminate, paper, etc. According to an illustrative embodiment of the present disclosure, the substrate may be a self-stick material capable of attachment to the panel. According to an illustrative embodiment of the present disclosure, the self-stick material is a “peel and stick” material. According to an illustrative embodiment of the present disclosure, the self-stick material is a self-stick plastic film.

According to an illustrative embodiment of the present disclosure, a panel or to one or more walls of the enclosure includes a positioning template to which schematic-like representations of the electronic components to be mounted to the panel can be positioned. According to an illustrative embodiment of the present disclosure, the schematic-like representations of the electronic components are provided on a self-stick material. According to an illustrative embodiment of the present disclosure, the self-stick material is a “peel and stick” material. According to an illustrative embodiment of the present disclosure, the self-stick material is a self-stick plastic film.

In certain illustrative embodiments described herein, one or more components of a panel and/or enclosure may be constructed from metal (e.g., stamped steel, spring steel, and aluminum), plastic (e.g., polycarbonate or nylon) or a combination of such materials. Alternatively, steel, brass or other appropriate alloy may be used for the appropriate components. Of course, other types of materials such as other types of plastics, composites, etc. may be used as desired and where appropriate.

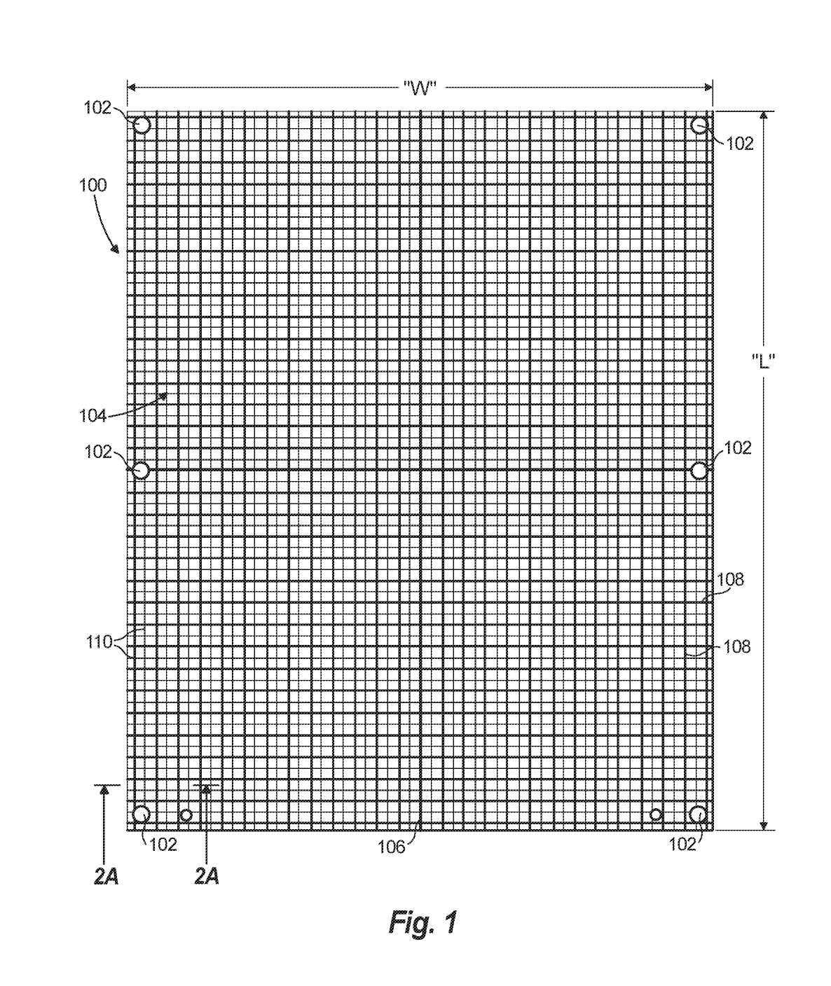

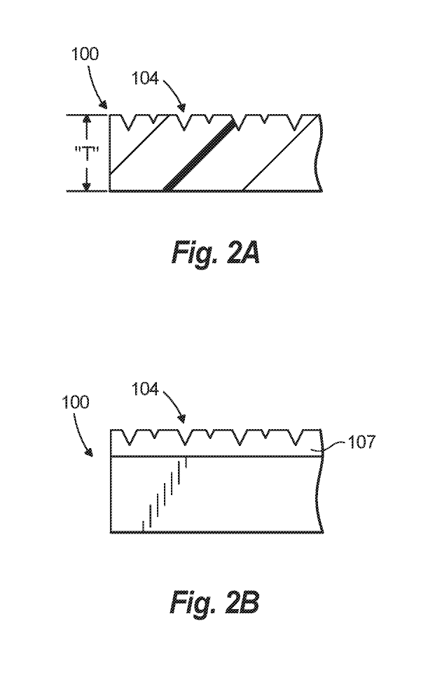

A panel including a positioning template according to an illustrative embodiment of the present disclosure is shown in FIGS. 1 and 2A and is referred to generally as panel 100. Panel 100 may be etched, inked, silk-screened or marked to include the positioning template 104. In the illustrative embodiment of FIG. 2A, the positioning template 104 is etched on the panel 100. Alternatively, the positioning template 104 may be provided on a substrate 107 which is attached to the panel 100, as seen in FIG. 2B. Electrical and/or electronic components (not shown) may be mounted to panel 100 using any suitable type of attaching device including, for example, screws, nuts/bolts, etc. Panel 100 may be provided in various dimensions suitable for particular applications. For example, a panel 100 having a particular length “L” and width “W” can be selected depending on the number and size of electronic components to be mounted. The thickness “T” of panel 100, seen in FIG. 2A, may vary depending on the type of material forming panel 100. For example, a panel 100 formed from a metal may be ⅛ inch thick or less and still provide a suitably stable panel. A panel 100 formed from a plastic or other such material may be ⅛ inch thick or more to provide a suitably stable panel. Panel 100 includes a plurality of holes 102 provided along the peripheral edge dimensioned for receiving screws or nuts/bolts for mounting panel 100 to a structure such as an enclosure, wall, beam or other such structure. The positioning template 104 covers at least a portion of the face of panel 100. According to the illustrative embodiments of the present disclosure shown in FIGS. 1, 2A and 2B, the positioning template 104 is a grid-like pattern and the panel 100 is approximately 13″ wide by 16″ long by ⅛ inch thick. The horizontal and vertical thick dark lines 106 cross at the center of the panel 100. The horizontal and vertical thin dark lines 108 crisscross and form ¼″ by ¼″ boxes. The horizontal and vertical light lines 110 crisscross and form ⅛″ by ⅛″ boxes. It should be clear the lines forming the grid-like pattern may be dimensioned differently as desired depending on a particular application. The grid-like pattern on positioning template 104 allows electrical and/or electronic components to be accurately positioned on the panel 100 in accordance with design specifications or in a manner to arrange the electrical and/or electronic components perpendicular and parallel to each other. Of course, the grid-like pattern on positioning template 104 can be in metric dimensions, logarithmic dimensions, etc. as suitable for a particular application. Alternatively, the grid-like pattern on positioning template 104 may simply consist of horizontal and vertical lines arranged having no particular units of dimensions.

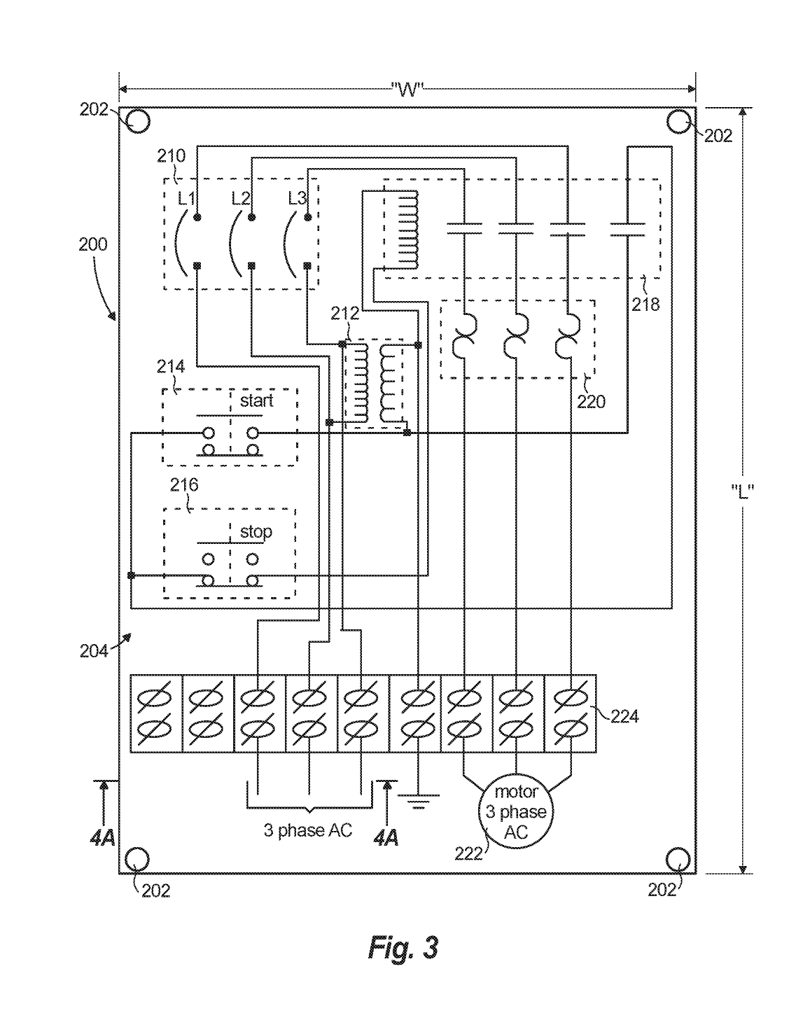

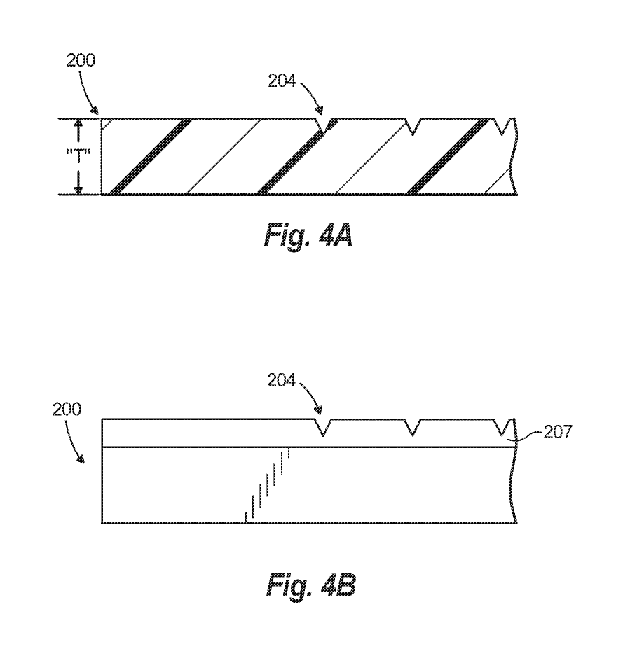

A panel including a positioning template according to another illustrative embodiment of the present disclosure is shown in FIGS. 3 and 4A and is referred to generally as panel 200. Panel 200 may be etched, inked, silk-screened or marked to include the positioning template 204. In the illustrative embodiment of FIG. 4A, the positioning template 204 is etched on the panel 200. Alternatively, the positioning template 204 may be provided on a substrate 207 which is attached to the panel 200, as seen in FIG. 4B. Electrical and/or electronic components (not shown) may be mounted to panel 200 using any suitable type of attaching device including, for example, screws, nuts/bolts, etc. Panel 200 may be provided in various dimensions suitable for particular applications. For example, a panel 200 having a particular length “L” and width “W” can be selected depending on the number and size of electronic components to be mounted. The thickness “T” of panel 200, seen in FIG. 4A, may vary depending on the type of material forming panel 200. For example, a panel 200 formed from a metal may be ⅛ inch thick or less and still provide a suitably stable panel. A panel 200 formed from a plastic or other such material may be ⅛ inch thick or more to provide a suitably stable panel. Panel 200 includes a plurality of holes 202 provided along the peripheral edge dimensioned for receiving screws or nuts/bolts for mounting panel 200 to a structure such as a panel enclosure, wall, beam or other such structure. The face of panel 200 includes the positioning template 204. According to the illustrative embodiments of the present disclosure shown in FIGS. 3, 4A and 4B, the positioning template 204 is a schematic representation of the electrical and/or electronic components to be attached to the panel 200. According to an embodiment of the present disclosure, each electrical and/or electronic component (210, 211, 212, 214, 218, 220, 222 and 224) depicted in the schematic-like representation is the size of the actual component itself. This allows the actual components to be positioned over the corresponding components illustrated on the schematic so that they oriented in accordance with design specifications or so that the components are oriented parallel and/or perpendicular to each other. The wiring depicted in the schematic allows the electronic components to be easily and accurately interconnected. According to another illustrative embodiment of the present disclosure, the electrical and/or electronic components depicted in the schematic are not drawn to size. In this case, the schematic on the panel 200 is conveniently positioned in front of the user when the components are being mounted and/or interconnected.

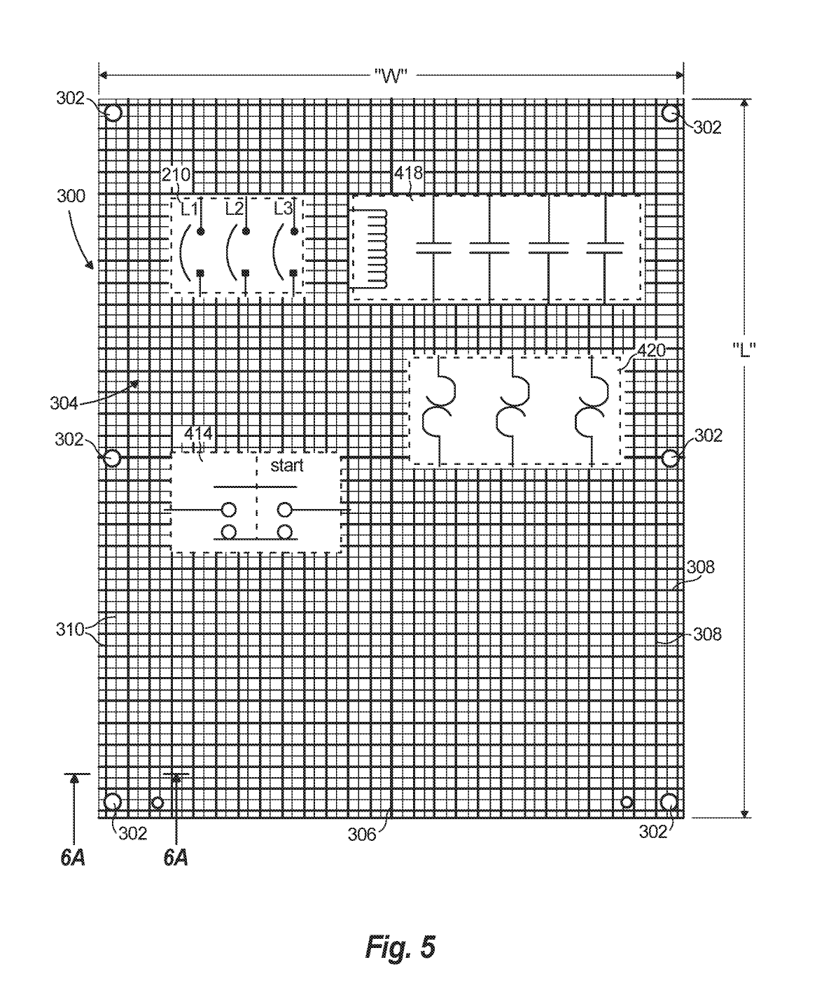

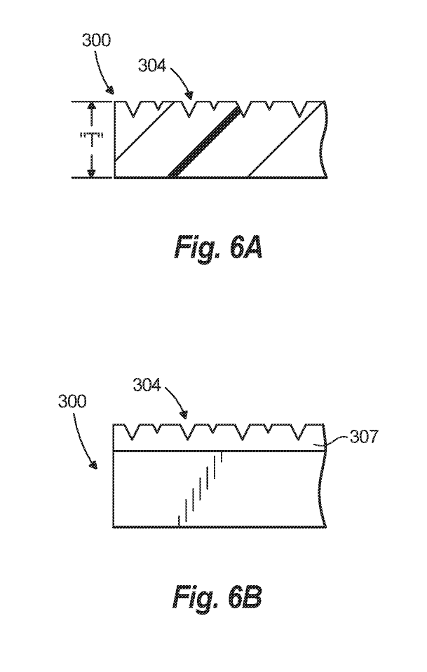

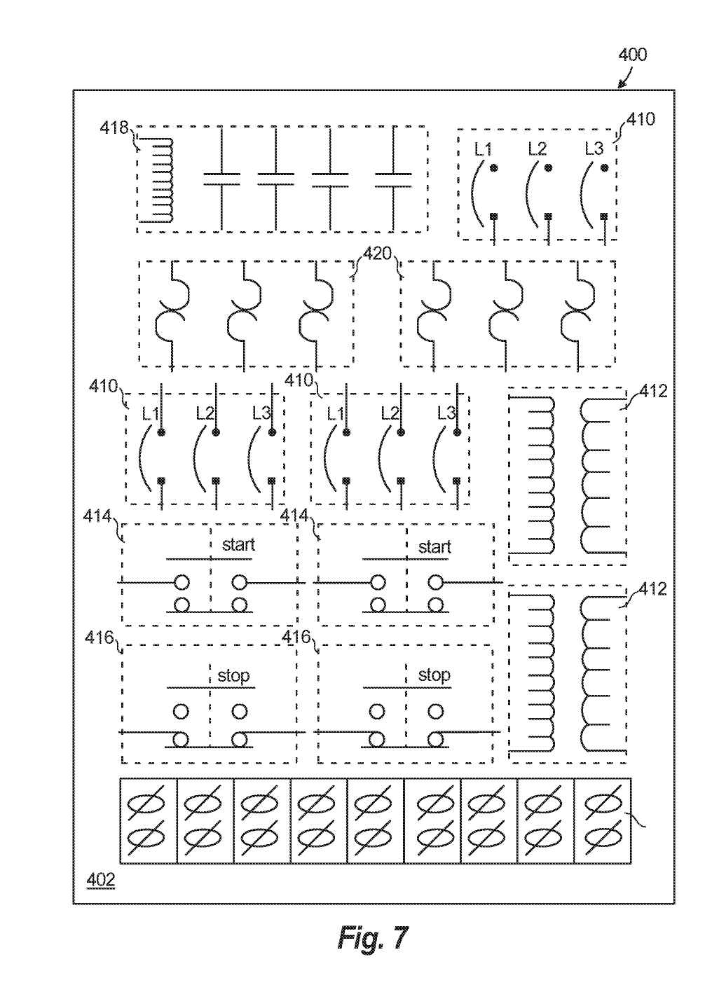

A panel including a positioning template according to another illustrative embodiment of the present disclosure is shown in FIGS. 5 and 6A and is referred to generally as panel 300. Panel 300 may be etched, inked, silk-screened or marked to include the positioning template 304. In the illustrative embodiment of FIG. 6A, the positioning template 304 is etched on the panel 300. Alternatively, the positioning template may be provided on a substrate 307 which is attached to the panel 300, as seen in FIG. 6B. Electrical and/or electronic components may be mounted to panel 300 using any suitable type of attaching device including, for example, screws, nuts/bolts, etc. Panel 300 may be provided in various dimensions suitable for particular applications. For example, a panel 300 having a particular length “L” and width “W” can be selected depending on the number and size of electronic components to be mounted. The thickness “T” of panel 300, seen in FIG. 6A, may vary depending on the type of material forming panel 300. For example, a panel 300 formed from a metal may be ⅛ inch thick or less and still provide a suitably stable panel. A panel 300 formed from a plastic or other such material may be ⅛ inch thick or more to provide a suitably stable panel. Panel 300 includes a plurality of holes 302 provided along the peripheral edge dimensioned for receiving screws or nuts/bolts for mounting panel 300 to a structure such as a panel enclosure, wall, beam or other such structure. The positioning template 304 covers at least a portion of the face of panel 300. According to the illustrative embodiments of the present disclosure shown in FIGS. 5, 6A and 6B, the positioning template 304 includes a grid-like pattern similar to that depicted in FIGS. 1 and 2A. The horizontal and vertical thick dark lines 306 cross at the center of the panel 300. The horizontal and vertical thin dark lines 308 crisscross and form ¼″ by ¼″ boxes. The horizontal and vertical light lines 310 crisscross and form ⅛″ by ⅛″ boxes. It should be clear the lines forming the grid-like pattern may be dimensioned differently as desired for a particular application. According to the present illustrative embodiment, self-stick schematic replicas (FIG. 7) for various types of electronic components are provided on a sheet of backing material 402. The self-stick schematic replicas (410, 412, 414, 416, 418, 420 and 422) may be formed from a “peel and stick” material or from a self-stick plastic film 400. The end user can arrange and rearrange the schematic replicas on the grid-like pattern 304 (FIG. 5) until satisfied with the arrangement. The end user can then attach the “peel and stick” or self-stick plastic film schematic replicas (410, 412, 414, 416, 418, 420, and 422) to the grid-like pattern. If desired, the end user can use a marker to apply the lines interconnecting the electrical and/or electronic components. Alternatively, self-stick connecting line replicas can be provided. The grid-like pattern on positioning template 304 allows the schematic replicas (410, 412, 414, 416, 418, 420 and 422) of the electrical and/or electronic components to be accurately positioned in accordance with design specifications or so that they are perpendicular and parallel to each other. Of course, the grid-like pattern on positioning template 304 can be in metric dimensions, logarithmic dimensions, etc. as suitable for a particular application. Alternatively, the grid-like pattern on positioning template 304 may simply consist of horizontal and vertical lines arranged having no particular units of dimensions. According to an illustrative embodiment of the present disclosure, each electrical and/or electronic component (410, 412, 414, 416, 418, 420 and 422) depicted in the schematic is the size of the actual component itself. This allows the actual components to be positioned over the corresponding components illustrated on the schematic so that they are oriented in accordance with design specifications or so that they are parallel and/or perpendicular to each other. According to another illustrative embodiment of the present disclosure, the electronic components (410, 412, 414, 416, 418, 420 and 422) are not drawn to size. In this case, the schematic on the panel 300 is conveniently positioned in front of the user when the components are being mounted and/or interconnected.

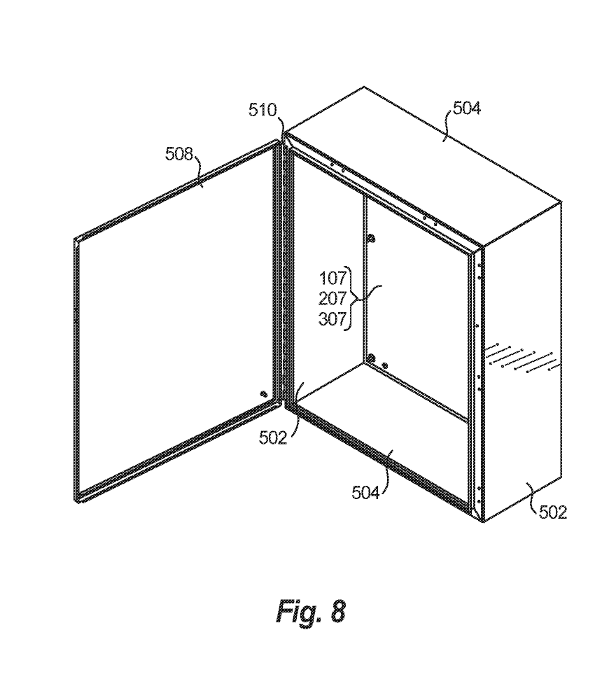

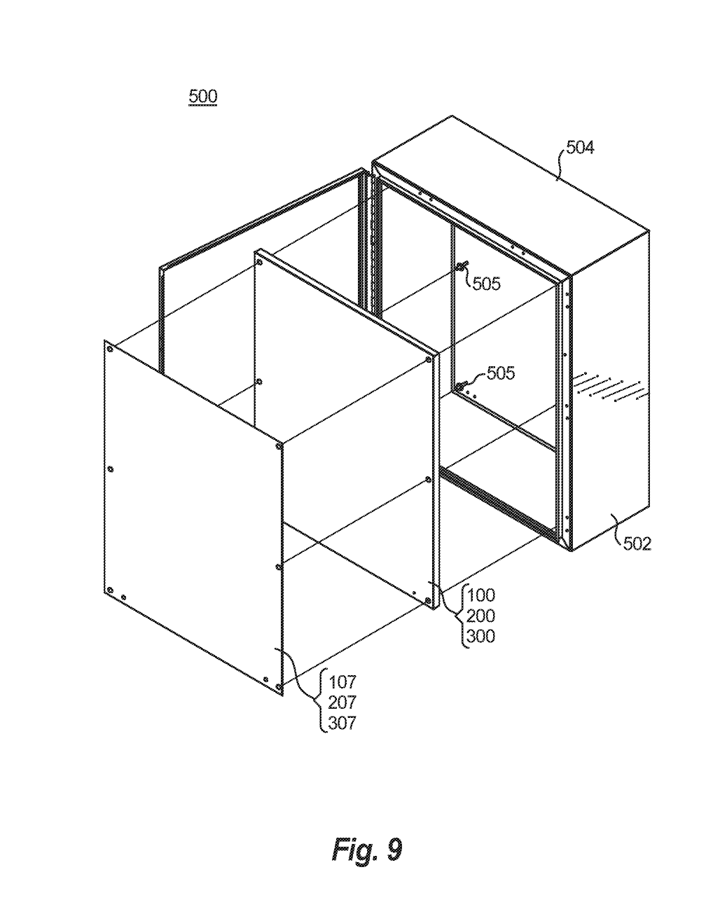

An enclosure according to an illustrative embodiment of the present disclosure is shown in FIGS. 8 and 9 and is referred to generally as enclosure 500. Enclosure 500 includes side walls 502 and top and bottom walls 504. Side walls 502 and top and bottom walls 504 can be welded, soldered, riveted or otherwise attached together as shown. A door 508 may be attached to a side wall 502 or one of the top and bottom walls 504 by one or more hinges 510. A locking mechanism (not shown) may be provided on the door 508. Referring to FIG. 9, enclosure 500 includes a panel such as one of the panels 100, 200 and 300 described in the above embodiments which is attached to, for example, a rear wall of enclosure 500 utilizing threaded stand-off studs 505. As described in the above embodiments, panels 100, 200 and 300 may be etched, inked or otherwise marked with a positioning template described in the above embodiments. Alternatively, the positioning template may be provided on a substrate 107, 207 and 307 as described in the above embodiments which can be attached to the back panel 100-300. As noted above, the substrate 107, 207 and 307 may include at least one of cardboard, plastic, laminate, paper, etc. According to an illustrative embodiment of the present disclosure, the substrate 107, 207 and 307 may be a self-stick material capable of attachment to the panel 100, 200, 300. Non-limiting examples of self-stick materials includes “peel and stick” materials and self-stick plastic films.

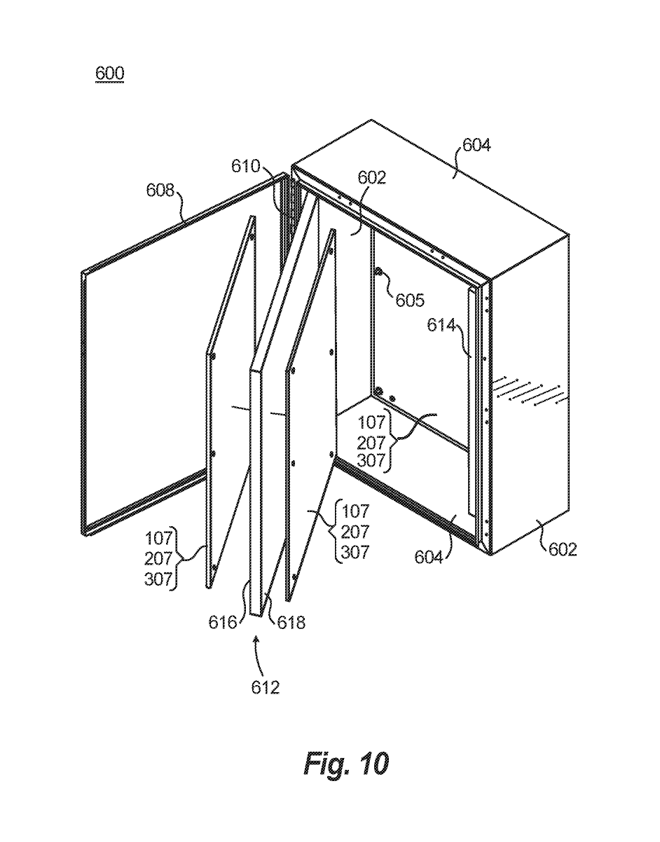

An enclosure according to another illustrative embodiment of the present disclosure is shown in FIG. 10 and is referred to generally as enclosure 600. Enclosure 600 includes side walls 602 and top and bottom walls 604. Side walls 602 and top and bottom walls 604 can be welded, soldered, riveted or otherwise attached together as shown. A door 608 may be attached to a side wall 602 or one of the top and bottom walls 604 by one or more hinges 610. A locking mechanism (not shown) may be provided on the door 608. The enclosure 600 may include a panel such as one of the panels 100, 200 and 300 described in the above embodiments which is attached to, for example, a rear wall of enclosure 600 utilizing threaded stand-off studs 605. In this illustrative embodiment, a swing panel 612 is pivotably secured to the top and walls 604 on one side of the panel and a stop 614 limits the distance the swing panel can rotate into the enclosure. As described in the above embodiments, the panels 100, 200 and 300 may be etched, inked or otherwise marked with a positioning template described in the above embodiments. Similarly, the front surface 616 and/or rear surface 618 of the swing panel 612 may be etched, inked or otherwise marked with a positioning template described in the above embodiments. Alternatively, the positioning template may be provided on a substrate 107, 207 and 307 as described in the above embodiments that can be attached to the back panel 100, 200, 300. Similarly, the positioning template may be provided on a substrate 107, 207 and 307 as described in the above embodiments that can be attached to the front surface 616 and/or rear surface 618 of the swing panel 612. As noted above, the substrate 107, 207 and 307 may include at least one of cardboard, plastic, laminate, paper, etc. According to an illustrative embodiment, the substrate 107, 207 and 307 may be a self-stick material capable of attachment to the panel 100, 200, 300. Non-limiting examples of self-stick materials includes “peel and stick” materials and self-stick plastic films.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A panel positioning template comprising:
a substrate; and
a template provided on the substrate and providing a visual indication for positioning of electronic components.

2. The panel positioning template of claim 1, wherein substrate comprises an electronic component panel to which electronic components are to be mounted.

3. The panel positioning template of claim 2, wherein the template is etched on the panel.

4. The panel positioning template of claim 2, wherein the template is marked onto the panel using at least one of permanent and removable markings.

5. The panel positioning template of claim 1 wherein the substrate is capable of being attached to an electronic component panel to which electronic components are to be mounted.

6. The panel positioning template of claim 5, wherein the substrate comprises at least one of cardboard, plastic, laminate and paper.

7. The panel positioning template of claim 5, wherein the substrate comprises a self-stick material capable of attachment to the electronic component panel.

8. The panel positioning template of claim 7, wherein the self-stick material comprises at least one of a “peel and stick” material and a self-stick plastic film.

9. The panel positioning template of claim 1, wherein the template comprises a grid-like pattern.

10. The panel positioning template of claim 1, wherein the template comprises schematic-like representations of the electronic components.

11. The panel positioning template of claim 1, wherein the template comprises a grid-like pattern and schematic-like representations of the electronic components.

12. The panel positioning template of claim 11, wherein the grid-like pattern is etched on the substrate.

13. The panel positioning template of claim 11, wherein the grid-like pattern is marked onto the substrate using at least one of a permanent and removable marking.

14. The panel positioning template of claim 11, wherein the schematic-like representations of the electronic components are attachable to the grid-like pattern.

15. The panel positioning template of claim 14, wherein the schematic-like representations of the electronic components are formed on a self-stick material capable of attachment to the grid-like pattern.

16. The panel positioning template of claim 15, wherein the self-stick material comprises at least one of a “peel and stick” material and a self-stick plastic film.

17. A panel enclosure comprising:
four side panels forming an enclosed area;
a back panel enclosing a back of the enclosed area; and
a positioning template provided on the back panel, the positioning template providing a visual indication for positioning electronic components within the enclosed area.

18. The panel enclosure of claim 17, wherein the positioning template is etched on the back panel.

19. The panel enclosure of claim 17, wherein the positioning template is marked onto the back panel using at least one of permanent and removable markings.

20. The panel enclosure of claim 17, wherein the positioning template comprises at least one of cardboard, plastic, laminate and paper.

21. The panel enclosure of claim 17, wherein the positioning template comprises a self-stick material capable of attachment to the back panel.

22. The panel enclosure of claim 21, wherein the self-stick material comprises at least one of a “peel and stick” material and a self-stick plastic film.

23. The panel enclosure of claim 17, wherein the positioning template comprises a grid-like pattern.

24. The panel enclosure of claim 17, wherein the positioning template comprises schematic-like representations of the electronic components.

25. The panel enclosure of claim 17, wherein the positioning template comprises a grid-like pattern and schematic-like representations of the electronic components.

26. The panel enclosure of claim 25, wherein the grid-like pattern is etched on the back panel or marked onto the back panel using at least one of permanent and removable markings.

27. The panel enclosure of claim 26, wherein the schematic-like representations of the electronic components are attachable to the grid-like pattern.

28. The panel enclosure of claim 27, wherein the schematic-like representations of the electronic components are formed on a self-stick material capable of attachment to the grid-like pattern.

29. The panel enclosure of claim 28, wherein the self-stick material comprises at least one of a “peel and stick” material and a self-stick plastic film.

30. The panel enclosure of claim 17, further comprising a swing panel pivotable secured to at least one of the four side panels, the swing panel comprising a front surface and a rear surface, and a positioning template provided on at least one of the front surface and rear surface, the positioning template providing a visual indication for positioning electronic components on the swing panel.

31. The panel enclosure of claim 30, wherein the positioning template is etched on the at least one of the front surface and rear surface.

32. The panel enclosure of claim 30, wherein the positioning template is marked onto at least one of the front surface and rear surface using at least one of permanent and removable markings.

33. The panel enclosure of claim 30, wherein the positioning template comprises at least one of cardboard, plastic, laminate and paper.
